(19) United States
(12) Patent Application Publication
(10) Pub. No.: US 2015/0177554 A1
(43) Pub. Date: Jun. 25, 2015

(54) LIQUID CRYSTAL MODULE AND FRONT FRAME STRUCTURE THEREOF

(71) Applicant: Shenzhen China Star Optoelectronics Technology Co., Ltd., Shenzhen (CN)

(72) Inventor: Dehua Li, Shenzhen (CN)

(21) Appl. No.: 13/703,367

(22) PCT Filed: Aug. 30, 2012
(86) PCT No.: PCT/CN2012/080800

§ 371 Date: Mar. 16, 2015

(30) Foreign Application Priority Data
Aug. 21, 2012 (CN) 201210298998.9

(51) Int. Cl. G02F 1/1333; G02F 1/1335; F21V 8/00

(52) U.S. Cl. CPC G02F 1/133308; G02B 6/005; G02B 6/0088; G02F 1/1336; G02F 2001/13332

(57) ABSTRACT

The present invention discloses a liquid crystal module and a front frame structure thereof. The liquid crystal module comprises a backlight module, a liquid crystal panel and a front frame structure. The liquid crystal panel is disposed on the backlight module; and the front frame structure is used to press and fix the liquid crystal panel onto the backlight module. In the present invention, by using a front frame structure of transparent material, the liquid crystal module has an effect of narrow frame/non frame in appearance, and has better fixing strength.

### FIELD OF THE INVENTION

The present invention relates to a liquid crystal module, and more particularly to a liquid crystal module having a transparent front frame structure.

### BACKGROUND OF THE INVENTION

A liquid crystal display (LCD) is a kind of flat panel display (FPD) which displays images by the property of the liquid crystal material. In comparison with other display devices, the LCD has the advantages in lightweight, compactness, low driving voltage and low power consumption, and thus has already become the mainstream product in the whole consumer market. However, the liquid crystal material of the LCD cannot emit light by itself, and must depend upon an external light source. Thus, the LCD further has a backlight module to provide the needed light source.

Generally speaking, backlight modules have been developed based on size requirements into a type of edge lighting structures and another type of bottom lighting structures, which are categorized by locations of lamp tubes thereof. A light source of the type of edge lighting structures is a single light source placed aside, and a light source of the type of bottom lighting structures is placed right beneath. The lamp tubes of the backlight modules must be featured with high brightness and a long lifespan, etc. They currently include cold cathode fluorescent lamps (CCFL), hot cathode fluorescent lamps, light emitting diodes (LED) and electroluminescence (EL), etc.

Among them, the CCFL has characters of high luminance, high efficiency, a long lifespan, and high color rendering, etc. Besides, it is much easier to be assembled with light reflection components to form a thin-sheet lighting device due to its cylinder shape. Therefore, using the CCFL as main backlight sources was once a main trend for making backlight modules. However, the CCFL is gradually eliminated by the present trend of soaring environmental awareness today due to its filled content of mercury vapors. Since using LED as backlight sources has an advantage of energy saving and environmental protection over the CCFL, it becomes a trend in backlight development to replace the CCFL by the LED. A lighting structure of the LED is generally called as a light bar in practice.

By using an LED as a backlight source, an LCD or an LCD TV is further developed toward a design direction of narrow frame. However, in a general design, when the frame is narrower, the place which the front frame of the liquid crystal module presses and covers the liquid crystal panel will become narrower, so the liquid crystal panel is easy out from the frame, so that the product reliability will be decreased substantially.

As a result, it is necessary to provide a liquid crystal module and a front frame structure thereof to solve the problems existing in the conventional technologies.

### SUMMARY OF THE INVENTION

A primary object of the present invention is to provide a liquid crystal module and a front frame structure thereof, so as to solve the problem existing in the conventional technologies: when an LCD or an LCD TV is developed toward a design direction of narrow frame, the front frame of the liquid crystal module becomes smaller, so the liquid crystal panel is easy out from the frame.

To achieve the above object, the present invention provides a liquid crystal module, which comprises:

a backlight module;

a liquid crystal panel disposed on the backlight module; and

a front frame structure which is made of a transparent material and comprises a plurality of side-frame portions and a plurality of upper-edge portions, wherein the side-frame portions are fixed on the backlight module, and the upper-edge portions press and fix the liquid crystal panel onto the backlight module downward from the top, and the front frame structure is fixed on the backlight module by means of engagement or means of screw joint.

In one embodiment of the present invention, the area of the backlight module is equal or smaller than the area of the liquid crystal panel.

In one embodiment of the present invention, the backlight module comprises:

a back plate;

a light guide plate disposed on the back plate;

an optical film assembly disposed on the light guide plate;

at least one light emitting diodes light bar disposed at one edge of the light guide plate and emitting the light toward the light guide plate; and

a plastic frame disposed at the edges of the back plate, which presses and fixes the optical film assembly and the light guide plate onto the back plate.

To achieve the above object, the present invention further provides a liquid crystal module, which comprises:

a backlight module;

a liquid crystal panel disposed on the backlight module; and

a front frame structure which is made of a transparent material and comprises a plurality of side-frame portions and a plurality of upper-edge portions, wherein the side-frame portions are fixed on the backlight module, and the upper-edge portions press and fix the liquid crystal panel onto the backlight module downward from the top.

In one embodiment of the present invention, the front frame structure is fixed on the backlight module by means of engagement or means of screw joint.

In one embodiment of the present invention, the front frame structure is a segment-assembly type of front frame structure.

In one embodiment of the present invention, the area of the backlight module is equal or smaller than the area of the liquid crystal panel.

In one embodiment of the present invention, the backlight module comprises:

a back plate;

a light guide plate disposed on the back plate;

an optical film assembly disposed on the light guide plate;

at least one light emitting diodes light bar disposed at one edge of the light guide plate and emitting the light toward the light guide plate; and

a plastic frame disposed at the edges of the back plate, which presses and fixes the optical film assembly and the light guide plate onto the back plate.

To achieve the above object, the present invention further provides a front frame structure of a liquid crystal module, which is made of a transparent material and comprises a plurality of side-frame portions and a plurality of upper-edge portions; wherein the side-frame portions are fixed on the backlight module, and the upper-edge portions press and fix the liquid crystal panel onto the backlight module downward from the top.

In one embodiment of the present invention, the transparent material of the front frame structure is a transparent plastic material.

In one embodiment of the present invention, the front frame structure is fixed to the backlight module by a plurality of screw elements.

In one embodiment of the present invention, lower edges of the side-frame portions of the front frame structure further comprise a plurality of lower engaging portions, which is engaged with and fixed to corresponding a plurality of engaging grooves of the backlight module.

In one embodiment of the present invention, the front frame structure comprises four strip-like segment type of front frame structure.

In the present invention, by using a front frame structure of transparent material, the liquid crystal module has an effect of narrow frame/non frame in appearance, and has better fixing strength.

### DESCRIPTION OF THE DRAWINGS

FIG. 1 is an exploded perspective schematic view according to a first preferred embodiment of the present invention;

FIG. 2 is an assembled perspective schematic view according to the first preferred embodiment of the present invention;

FIG. 3 is a partial side cross-sectional view according to a second preferred embodiment of the present invention;

FIG. 4 is a partial side cross-sectional view according to a third preferred embodiment of the present invention; and

FIG. 5 is an explode perspective schematic view according to a fourth preferred embodiment of the present invention.

### DETAILED DESCRIPTION OF THE PREFERRED EMBODIMENTS

The foregoing objects, features and advantages adopted by the present invention can be best understood by Referring now to the following detailed description of the preferred embodiments and the accompanying drawings. Furthermore, the directional terms described in the present invention, such as upper, lower, front, rear, left, right, inner, outer, side and etc., are only directions Referring now to the accompanying drawings, so that the used directional terms are used to describe and understand the present invention, but the present invention is not limited thereto.

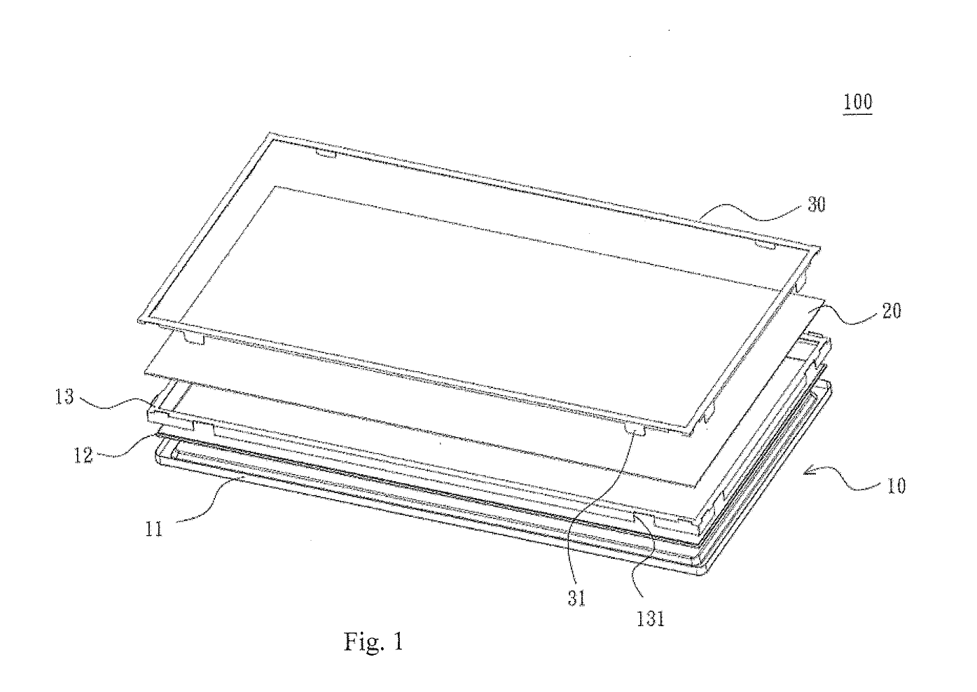

Referring now to FIG. 1, an exploded perspective schematic view according to a first preferred embodiment of the present invention is illustrated in FIG. 1. A liquid crystal module 100 according to the present invention comprises a backlight module 10, a liquid crystal panel 20 and a front frame structure 30. The liquid crystal panel 20 is disposed on the backlight module 10; and the front frame structure 30 is used to press and fix the liquid crystal panel 20 onto the backlight module 10.

Moreover, the front frame structure 30 comprises side-frame portions (not indicated) and upper-edge portions (not indicated), and the shape of the cross-section of the front frame structure 30 is approximately formed as an upside-down L-shape. The side-frame portions are fixed on the backlight module 10, and the upper-edge portions press and fix the liquid crystal panel 20 onto the backlight module 10 downward from the top.

In this preferred embodiment, the front frame structure 30 is made of a transparent material, and the transparent material preferably has a Light Transmission Rate of 95%. For example, the front frame structure 30 is made of a transparent plastic material, such as Polymethylmethacrylate (PMMA), Methyl methacrylate-styrene (MS) or Polycarbonate (PC). However, the material of the front frame structure 30 according to the present invention is not limited by that, any other material which is transparent and has a certain strength also can be considered used making the front frame structure 30 of the present invention.

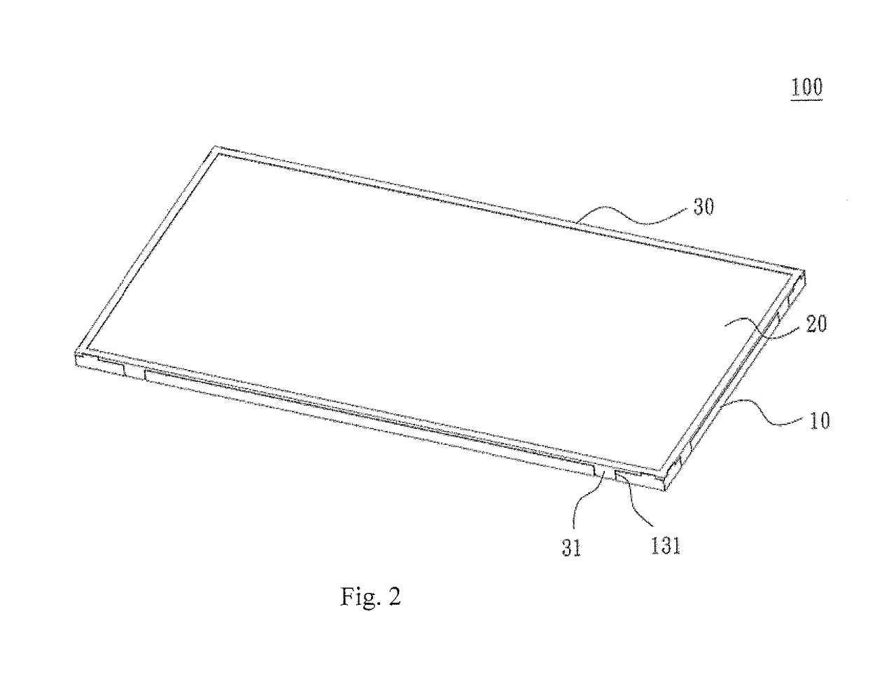

Referring now to FIG. 2, an assembled perspective schematic view according to the first preferred embodiment of the present invention is illustrated in FIG. 2. As shown in FIG. 2, the front frame structure 30 presses and fixes the liquid crystal panel 20 onto the backlight module 10, so as to assemble as the liquid crystal module 100. Hence, because the front frame structure 30 is made of a transparent plastic material, the upper-edge portions can be passed through by the image at edges of the liquid crystal panel 20. In other word, the upper-edge portions of the front frame structure 30 can be designed wider, so that the liquid crystal module 100 has an effect of narrow frame/non frame in appearance, and has better fixing strength.

Moreover, the front frame structure 30 can be fixed on the backlight module 10 by various kind of means. As shown in FIG. 1, In this preferred embodiment, the backlight module 10 comprises a back plate 11, a light guide plate 12 and a plastic frame 13, wherein the light guide plate 12 is disposed on the back plate 11; the plastic frame 13 is disposed at the edges of the back plate 11, and presses and fixes the light guide plate 12 onto the back plate 11 downward from the top. Lower edges of the side-frame portions of the front frame structure 30 further comprise a plurality of lower engaging portions 31, and the backlight module 10 is correspondingly has a plurality of engaging grooves 131. The lower engaging portions 31 of the front frame structure 30 are engaged and fixed with the engaging grooves 131 of the backlight module 10, so as to press and fix the liquid crystal panel 20 onto the backlight module 10.

Preferably, the area of the backlight module 10 is equal or smaller than the area of the liquid crystal panel 20, so it can control that the area of the backlight module 10 will be not bigger than the area of the liquid crystal panel 20, so as to match the narrow frame design of a liquid crystal display (LCD) or an LCD TV.

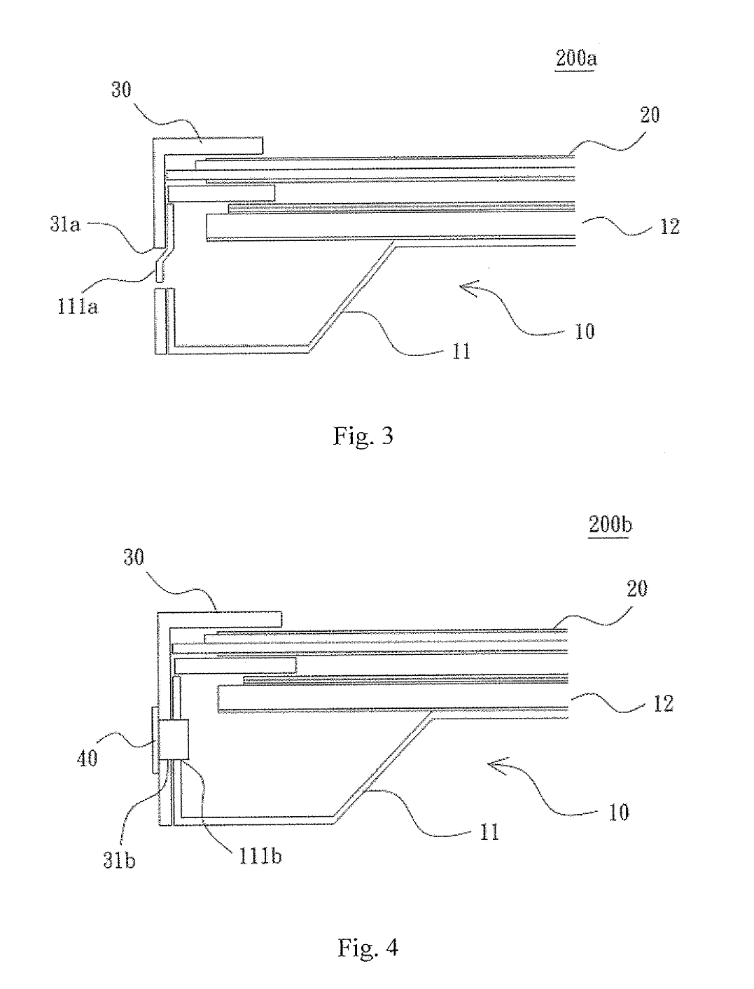

Referring now to FIG. 3, a partial side cross-sectional view according to a second preferred embodiment of the present invention is illustrated in FIG. 3. A liquid crystal module 100a according to the second preferred embodiment of the present invention is substantially similar to the liquid crystal module 100 according to the first preferred embodiment of the present invention, so as to use similar terms and numerals, but the difference therebetween is that: In this preferred embodiment, the front frame structure 30 is fixed on the backlight module 10 by means of engagement. As shown in FIG. 3, the backlight module 10 comprises a back plate 11, a light guide plate 12 and an optical film assembly (not indicated), wherein the light guide plate 12 is disposed on the back plate 11; the optical film assembly is disposed on the light guide plate 12. The backlight module 10 further comprises at least one light emitting diodes (LED) light bar (not shown), wherein the LED light bar is disposed at one edge of the light guide plate 12, and emits the light toward the light guide plate 12. Furthermore, the front frame structure 30 is provided with a plurality of holes 31a, and the backlight module 10 (such as on the back plate 11) is correspondingly provided with a plurality of hooks 111a. By the hooks 111a of the backlight module 10 and the holes 31a of the front frame structure 30, the front frame structure 30 is engaged and fixed with the backlight module 10, and presses and fixes a liquid crystal panel 20 onto the backlight module 10.

Referring now to FIG. 4, a partial side cross-sectional view according to a third preferred embodiment of the present invention is illustrated in FIG. 4. A liquid crystal module 100b according to the third preferred embodiment of the present invention is substantially similar to the liquid crystal module 100a according to the second preferred embodiment of the present invention, so as to use similar terms and numerals, but the difference therebetween is that: In this preferred embodiment, the front frame structure 30 is fixed on the backlight module 10 by means of screw joint. As shown in FIG. 4, the backlight module 10 is provided with a plurality of first holes 31b, and the backlight module 10 (such as on the back plate 11) is correspondingly provided with a plurality of second holes 111b. By using a screw element 40 passing through the first holes 31b of the front frame structure 30 and the second holes 111b of the backlight module 10, the front frame structure 30 is screwed and fixed with the backlight module 10, and presses and fixes a liquid crystal panel 20 onto the backlight module 10.

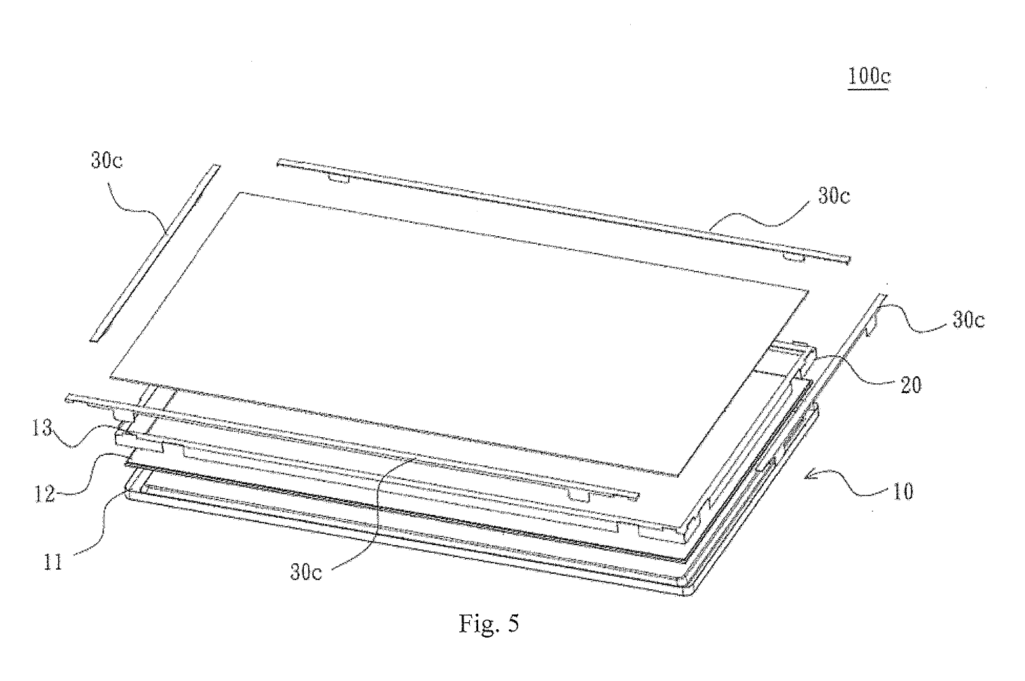

Referring now to FIG. 5, an explode perspective schematic view according to a fourth preferred embodiment of the present invention is illustrated in FIG. 5. A liquid crystal module 100c according to the fourth preferred embodiment of the present invention is substantially similar to the liquid crystal module 100 according to the first preferred embodiment of the present invention, so as to use similar terms and numerals, but the difference therebetween is that: In this preferred embodiment, the front frame structure is a segment-assembly type of front frame structure, namely, the front frame structure comprises four strip-like segment type of front frame structure 30a. the segment type of front frame structure 30a are engaged with or screwed to four side edges of the backlight module 10, respectively, so as to press and fix the liquid crystal panel 20 onto the backlight module 10. In this preferred embodiment, because the front frame structure is assembled by means of segment, the mold of the front frame structure 30a can be miniaturization, and it is possible that there is a common front frame member between the different sizes of the liquid crystal modules.

As described above, to compare with the traditional technology, when an LCD or an LCD TV is developed toward a design direction of narrow frame, the place which the front frame of the liquid crystal module presses and covers the liquid crystal panel will become smaller, so the liquid crystal panel is easy out from the frame, so that the product reliability will be decreased substantially. The liquid crystal module according to the present invention uses a front frame structure 30 of transparent material, so that the liquid crystal module has an effect of narrow frame/non frame in appearance, and has better fixing strength.

The present invention has been described with a preferred embodiment thereof and it is understood that many changes and modifications to the described embodiment can be carried out without departing from the scope and the spirit of the invention that is intended to be limited only by the appended claims.

1. A liquid crystal module, characterized in that: the liquid crystal module comprises:
a backlight module;
a liquid crystal panel disposed on the backlight module; and
a front frame structure which is made of a transparent material and comprises a plurality of side-frame portions and a plurality of upper-edge portions, wherein the side-frame portions are fixed on the backlight module, and the upper-edge portions press and fix the liquid crystal panel onto the backlight module downward from the top, and the front frame structure is fixed on the backlight module by means of engagement or means of screw joint.

2. The liquid crystal module according to claim 1, wherein the area of the backlight module is equal or smaller than the area of the liquid crystal panel.

3. The liquid crystal module according to claim 1, wherein the backlight module comprises:
a back plate;
a light guide plate disposed on the back plate;
an optical film assembly disposed on the light guide plate;
at least one light emitting diodes (LED) light bar disposed at one edge of the light guide plate and emitting the light toward the light guide plate; and
a plastic frame disposed at the edges of the back plate, which presses and fixes the optical film assembly and the light guide plate onto the back plate.

4. The liquid crystal module according to claim 1, wherein lower edges of the side-frame portions of the front frame structure further comprise a plurality of lower engaging portions, which is engaged with and fixed to corresponding a plurality of engaging grooves of the backlight module.

5. A liquid crystal module, characterized in that: the liquid crystal module comprises:
a backlight module;
a liquid crystal panel disposed on the backlight module; and
a front frame structure which is made of a transparent material and comprises a plurality of side-frame portions and a plurality of upper-edge portions, wherein the side-frame portions are fixed on the backlight module, and the upper-edge portions press and fix the liquid crystal panel onto the backlight module downward from the top.

6. The liquid crystal module according to claim 5, wherein the front frame structure is fixed on the backlight module by means of engagement or means of screw joint.

7. The liquid crystal module according to claim 5, wherein the front frame structure is a segment-assembly type of front frame structure.

8. The liquid crystal module according to claim 5, wherein the area of the backlight module is equal or smaller than the area of the liquid crystal panel.

9. The liquid crystal module according to claim 5, wherein the backlight module comprises:
a back plate;
a light guide plate disposed on the back plate;
an optical film assembly disposed on the light guide plate;
at least one LED light bar disposed at one edge of the light guide plate and emitting the light toward the light guide plate; and
a plastic frame disposed at the edges of the back plate, which presses and fixes the optical film assembly and the light guide plate onto the back plate.

10. A front frame structure of a liquid crystal module, wherein the front frame structure is made of a transparent material and comprises a plurality of side-frame portions and a plurality of upper-edge portions; and wherein the side-frame portions are fixed on the backlight module, and the upper-edge portions press and fix the liquid crystal panel onto the backlight module downward from the top.

11. The front frame structure according to claim 10, wherein the transparent material of the front frame structure is a transparent plastic material.

12. The front frame structure according to claim 10, wherein the front frame structure is fixed to the backlight module by a plurality of screw elements.

13. The front frame structure according to claim 10, wherein lower edges of the side-frame portions of the front frame structure further comprise a plurality of lower engaging portions, which is engaged with and fixed to corresponding a plurality of engaging grooves of the backlight module.

14. The front frame structure according to claim 10, wherein the front frame structure comprises four strip-like segment type of front frame structure.
